(19) United States
(12) Patent Application Publication
(10) Pub. No.: US 2014/0144293 A1
(43) Pub. Date: May 29, 2014

(54) PNEUMATIC TOOL CAPABLE OF PREVENTING DEFORMATION OF A FRONT HANDLE SECTION

(71) Applicant: Basso Industry Corp., Taichung (TW)

(72) Inventor: San-Yih Su, Taichung (TW)

(73) Assignee: Basso Industry Corp., Taichung (TW)

(21) Appl. No.: 14/090,649

(22) Filed: Nov. 26, 2013

(30) Foreign Application Priority Data
Nov. 28, 2012 (TW) 101144493

(51) Int. Cl. B25B 21/00

(52) U.S. Cl. CPC B25B 21/004
USPC 81/57.39

(57) ABSTRACT

A pneumatic tool includes a front handle section having an axial hole unit formed in a bifurcated front end, a bush unit extending into the axial hole unit, a driving head extending through the axial hole unit and obstructed by the bush unit, and a position limiting unit including at least one stop member disposed on an exposed section of the driving head, and a compression spring disposed between the bush unit and the driving head. The compression spring biases the stop member to contact the bush unit. As such, the driving head is fixed in the bifurcated front end of the front handle section, so as to prevent deformation of the bifurcated front end due to rotation of the driving head relative to the front handle section.

### CROSS-REFERENCE TO RELATED APPLICATION

This application claims priority of Taiwanese Application No. 101144493, filed on Nov. 28, 2012.

### BACKGROUND OF THE INVENTION

1. Field of the Invention

This invention relates to a pneumatic tool, and more particularly to a pneumatic tool capable of preventing deformation of a front handle section.

2. Description of the Related Art

Referring to FIG. 1, a conventional pneumatic tool 1 disclosed in U.S. Pat. No. 7,392,726 includes a front handle section 11, a first guide bush 12, a driving head 13, a second guide bush 14, two disc springs 15, a C-shaped retaining ring 16, a locking pin 17, and a plurality of washers 18, 19. The front handle section 11 has a bifurcated front end consisting of spaced-apart first and second annular hold portions 111, 112 each having axial hole 113 formed therethrough along an axis (X). During assembly, the first guide bush 12 and the driving head 13 are moved through the axial holes 113 in the second annular hold portion 112 to contact the first annular hold portion 111. Subsequently, the second guide bush 14, the disc springs 15, and washers 10 are moved through the axial hole 113 in the second annular hold portion 112 until the second guide bush 14 comes into contact with the washer 18, which is sleeved on the driving head 13 and abuts against a shoulder of the driving head 13. The C-shaped retaining ring 16 is disposed in the axial hole 113 in the second annular hold portion 112, so as to position the first and second guide bushes 12, 14, the driving head 13, and the washer 18 relative to the front handle section 11. The locking pin 17 is inserted through the driving head 13 in a direction perpendicular to the axis (X) to limit the positions of the washers 19 and the disc springs 19.

As such, the disc springs 15 bias the driving head 13 away from the washers 19 until the locking pin 17 comes into contact with the washers 19, so that the driving head 13 is positioned relative to the front handle section 11, thereby preventing movement of free ends of the first and second annular hold portions 111, 112 away from each other. That is, deformation of the bifurcated front end of the front handle section 11 can be avoided.

However, since the driving head 13 is moved into the first annular hold portion 111 through the axial hole 113 in the second annular hold portion 112 during assembly, the first annular hold portion 111 needs to have a shoulder portion for permitting the driving head 13 or the first guide bush 12 to abut thereon. In addition, during assembly of the driving head 13 to the front handle section 11, before the locking pin 17 is assembled to the driving head 13, the disc springs 15 and the washers 19 may drop from a space between the driving head 13 and the front handle section 11. As such, the conventional pneumatic tool 1 has a complicated structure, and is difficult to assemble. Furthermore, the disc springs 15 serve as means for biasing the driving head 13, and thus affect adversely smooth rotation of the driving head 13.

### SUMMARY OF THE INVENTION

The object of this invention is to provide a pneumatic tool that can overcome the above-mentioned disadvantages associated with the prior art.

According to this invention, there is provided a pneumatic tool comprising:

a front handle section having a first annular hold portion and a second annular hold portion that are spaced apart from each other, each of the first and second annular hold portions having an axial hole formed therethrough along an axis;

a bush unit including a shoulder member, the shoulder member being disposed on the second annular hold portion of the front handle section and having an inner side surface facing the first annular hold portion, and an outer side surface opposite to the inner side surface;

a driving head extending through the axial holes in the first and second annular hold portions and obstructed by the inner side surface of the shoulder member from removal from the front handle section through the axial hole in the second annular hold portion, the driving head having an exposed section extending outwardly from the outer side surface; and

a position limiting unit including at least one stop member disposed on the exposed section, at least one compression spring disposed between the inner side surface of the shoulder member and the driving head, and at least one abutment member disposed between the compression spring and the inner side surface of the shoulder member, the compression spring biasing the driving head away from the second annular hold portion along the axis to allow the stop member to contact the bush unit, so as to prevent the driving head from removal from the front handle section through the axial hole in the first annular hold portion.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a sectional view of a conventional pneumatic tool disclosed in U.S. Pat. No. 7,392,726;

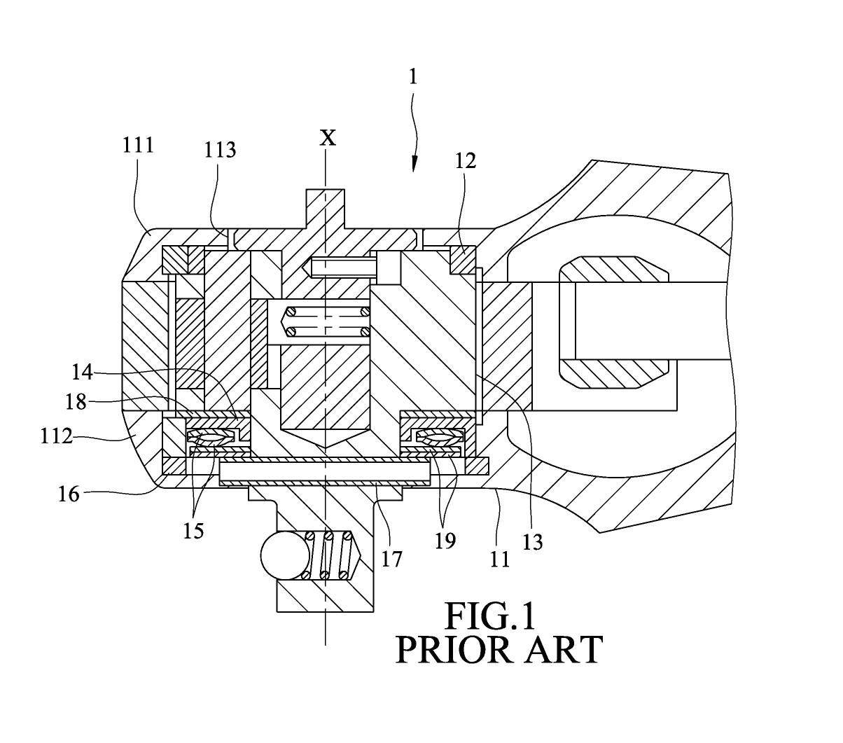

FIG. 2 is an exploded perspective view of the first preferred embodiment of a pneumatic tool according to this invention;

FIG. 3 is a sectional view of the first preferred embodiment;

FIG. 4 is another sectional view of the first preferred embodiment;

FIG. 5 is a sectional view of the second preferred embodiment of a pneumatic tool according to this invention;

FIG. 6 is a sectional view of the third preferred embodiment of a pneumatic tool according to this invention;

FIG. 7 is a sectional view of the fourth preferred embodiment of a pneumatic tool according to this invention;

FIG. 8 is a sectional view of the fifth preferred embodiment of a pneumatic tool according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

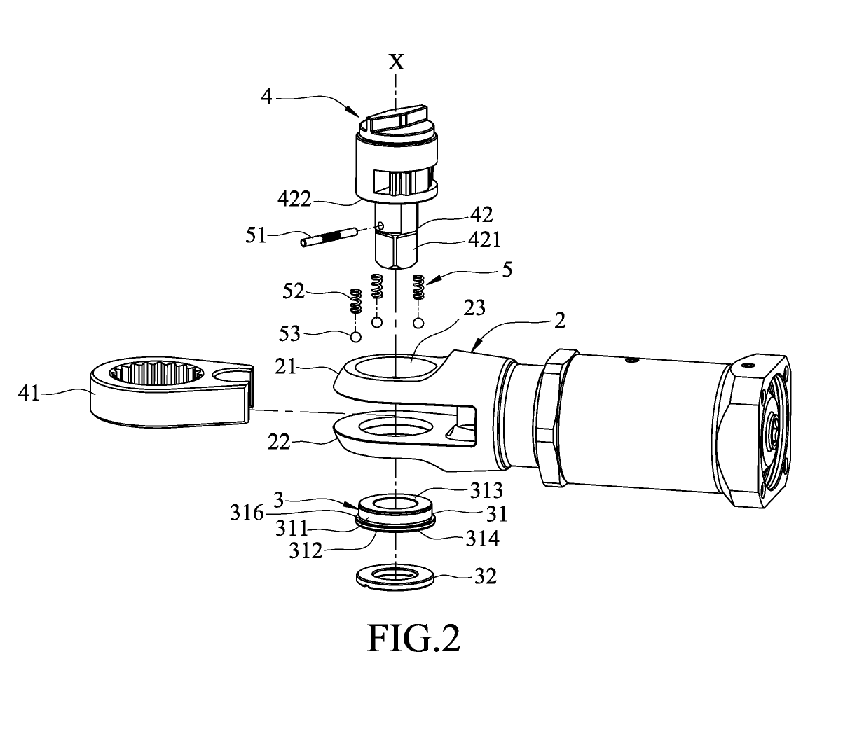

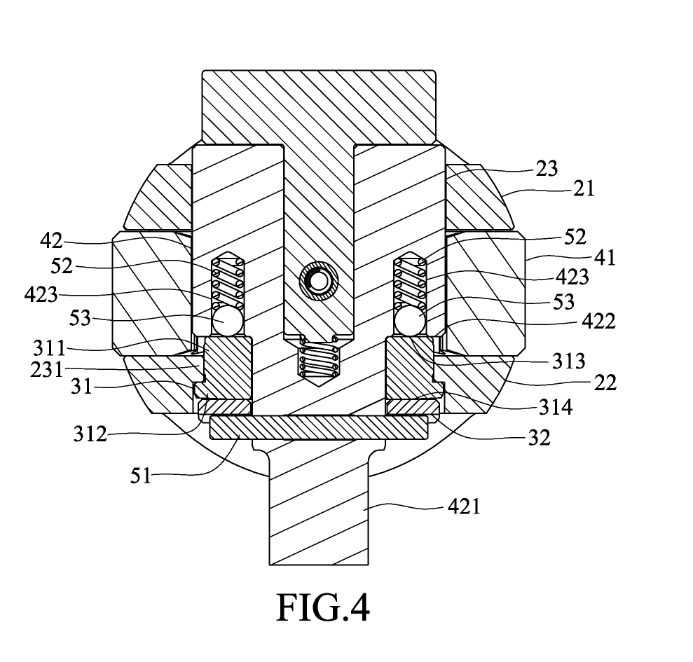

Referring to FIGS. 2, 3, and 4, the first preferred embodiment of a pneumatic tool according to this invention includes a front handle section 2, a bush unit 3, a driving unit 4, and a position limiting unit 5.

The front handle section 2 has a first annular hold portion 21 and a second annular hold portion 22 that are spaced apart from each other. Each of the first and second annular hold portions 21, 22 has an axial hole 23 formed therethrough along an axis (X). The axial holes 23 in the first and second annular hold portions 21, 22 cooperate to constitute an axial hole unit. The second annular hold portion 22 further ha a flange 231 extending into the axial hole 23.

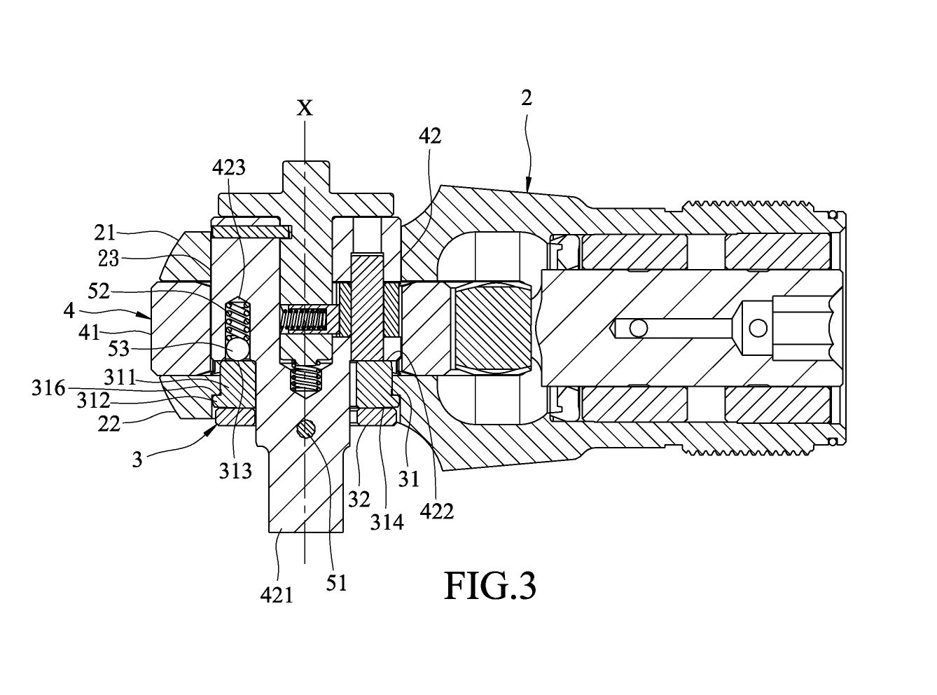

The bush unit 3 includes an annular shoulder member 31 and a washer 32. The shoulder member 31 has a small-diameter section 311 and a large-diameter section 312 that are interconnected. The large-diameter section 131 has an outer peripheral surface in contact with a wall of the second annular hold portion 22 defining the axial hole 23. The small-diameter section 311 has a diameter smaller than that of the large-diameter section 312 so as to define an annular shoulder surface 316 (see FIG. 3) therebetween. The annular shoulder surface 316 abuts against the flange 231. The shoulder member 31 further has an inner side surface 313 facing the first annular hold portion 21, and an outer side surface 314 opposite to the inner side surface 313. The washer 32 abuts against the outer side surface 314 of the shoulder member 31.

The driving unit 4 includes a ratchet sleeve 41 disposed between the first and second annular hole portions 21, 22, and a driving head 42 extending through the axial holes 23 in the first and second annular hold portions 21, 22 and the ratchet sleeve 41 and meshing with the ratchet sleeve 41. The driving head 42 has a maximum diameter smaller than the diameter of the axial hole 23 in the first annular hold portion 21, and extends through the axial hole 23 in the first annular hold portion 21 along the axis (X). The driving head 42 further has an exposed section 421 extending outwardly from the outer side surface 314 of the shoulder member 31 through the axial hole 23, and a shoulder surface 422 facing the inner side surface 313 of the shoulder member 31 and formed with three blind holes 423. As such, the driving head 42 is obstructed by the inner side surface 313 of the shoulder member 31 from removal from the front handle section 2 through the axial hole 23 in the second annular hold portion 22.

The position limiting unit 5 includes a stop member 51 extending through the exposed section 421 of the driving head 42 along a direction perpendicular to the axis (X) and abutting against the washer 32 of the bush unit 3, three compression springs 52 disposed respectively within the blind holes 423 in the driving head 42, and three abutment members 53 each disposed between and abutting against the corresponding compression spring 52 and the inner side surface 313 of the shoulder member 31. In this embodiment, the stop member 51 is configured as a pin, and each of the abutment members 3 is configured as a rolling member, such as a ball. As such, the compression springs 52 bias the driving head 42 away from the second annular hold portion 22 along the axis (X) to allow the stop member 51 to contact the washer 32 of the bush unit 3, so as to prevent the driving head 42 from removal from the front handle section 2 through the axial hole 23 in the first annular hold portion 21.

During assembly, the front handle section 2 is first rotated about its central axis to an angular position whereat the first annular hold portion 21 is disposed under the second annular hold portion 22. Next, the small-diameter section 311 of the shoulder member 31 is inserted into the axial hole 23 in the second annular hold portion 22 until the annular shoulder surface 316 comes into contact with the flange 231 of the second annular hold portion 22. The washer 32 is also placed into the axial hole 23 in the second annular hold portion 22 until it abuts against the outer side surface 314 of the shoulder member 31. Thereafter, the driving head 42 is inserted upwardly through the axial hole 23 in the first annular hold portion 21 and the ratchet sleeve 41 and into shoulder member 31 and the washer 32 until the shoulder surface 422 comes into contact with the inner side surface 313 of the shoulder member 31, so that the exposed section 421 projects outwardly from the second annular hold portion 22. Finally, an external force is applied to the driving head 42 along the X-axis to compress the compression springs 52, and the stop member 51 is inserted through the driving head 42.

When the external force is released, the stop member 51 is biased by the compression springs 52 to abut against the washer 32, so as to prevent removal of the driving head 42 from the front handle section 2 through the axial hole 23 in the first annular hold portion 21. In addition, since the shoulder surface 422 of the driving head 42 is obstructed by the inner side surface 313 of the shoulder member 31, removal of the driving head 42 from the front handle section 2 through the axial hole 23 in the second annular hold portion 22 is prevented. Furthermore, since the abutment members 53 are pressed against the inner side surface 313 of the shoulder member 31, the driving head 42 can be positioned relative to the front handle section 2. Further, since the abutment members 53 are configured as balls, smooth rotation of the driving head 42 is allowed, and the driving head 42 and the shoulder member 31 experience less wear.

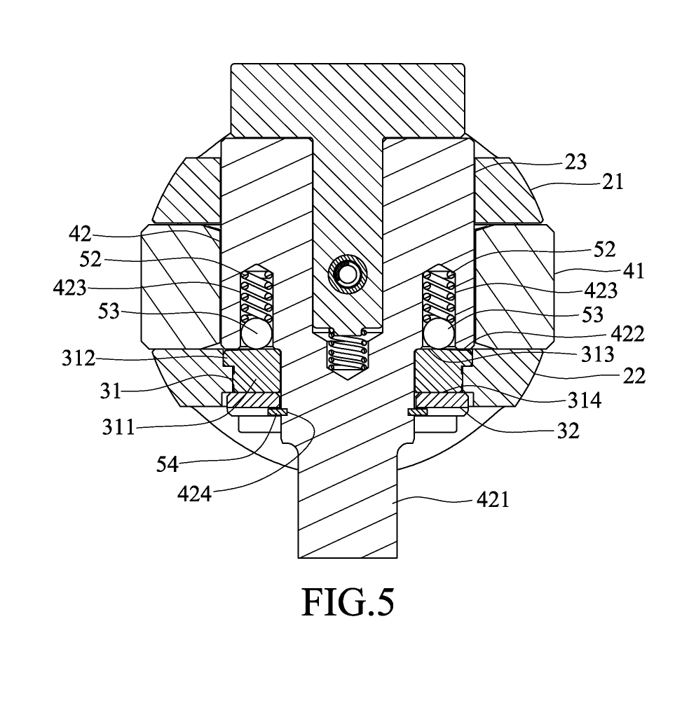

FIG. 5 shows the second preferred embodiment of a pneumatic tool according to this invention, which differs from the first preferred embodiment in the following.

The small-diameter section 311 has the outer side surface 314, and abuts against the washer 32. The large-diameter section 312 has the inner side surface 313, and abuts against the shoulder surface 422.

The exposed section 421 of the driving head 42 has an outer surface formed with an annular groove 424. The stop member 54 is configured as a C-shaped retaining ring, and is received within the annular groove 424.

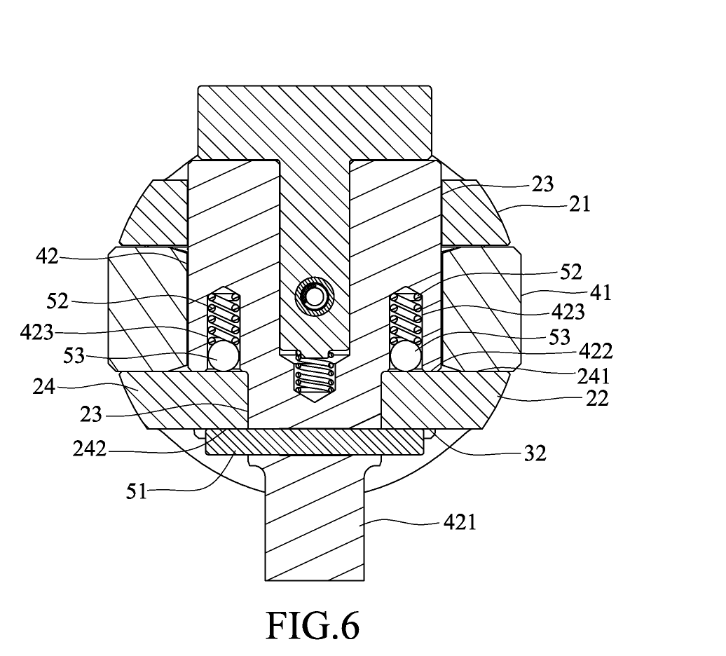

FIG. 6 shows the third preferred embodiment of a pneumatic tool according to this invention, which differs from the first preferred embodiment in the following.

The shoulder member 24 is formed integrally with the second annular hold portion 22, defines the axial hole 23, and has an inner side surface 241 facing the first annular hold portion 21, and an outer side surface 242 opposite to the inner side surface 241.

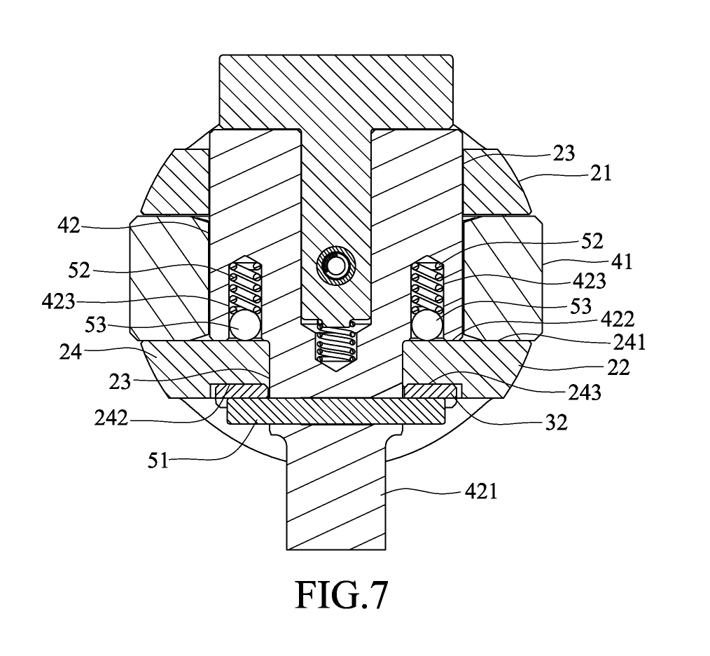

FIG. 7 shows the fourth preferred embodiment of a pneumatic tool according to this invention, which is similar to the third preferred embodiment except that the outer side surface 242 of the shoulder member 24 is formed with a recess 243, within which the washer 32 is disposed, so that, during rotation of the driving head 42, the shoulder member 24 and the second annular hold portion 22 cannot be scratched by the stop member 51.

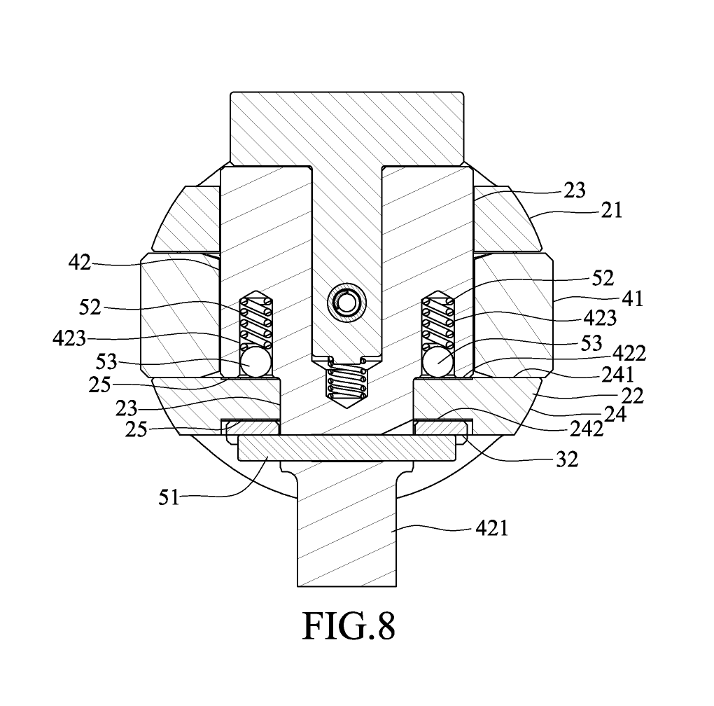

FIG. 8 shows the fifth preferred embodiment of a pneumatic tool according to this invention, which is similar to the fourth preferred embodiment except that the front handle section 2 further includes two washers 25.

One of the washers 25 is disposed between and abuts against the inner side surface 241 of the shoulder member 24 and the abutment members 53, so as to prevent contact between the shoulder member 24 and the abutment members 53. The other of the washers 25 is disposed between the outer side surface 242 of the shoulder member 24 and the stop member 51, so as to prevent contact between the stop member 51 and the shoulder member 24.

With this invention thus explained, it is apparent that numerous modifications and variations can be made without departing from the scope and spirit of this invention. It is therefore intended that this invention be limited only as indicated by the appended claims.

I claim:

1. A pneumatic tool comprising:
a front handle section having a first annular hold portion and a second annular hold portion that are spaced apart from each other, each of said first and second annular hold portions having an axial hole formed therethrough along an X-axis;
a bush unit including a shoulder member, said shoulder member being disposed on said second annular hold portion of said front handle section and having an inner side surface facing said first annular hold portion, and an outer side surface opposite to said inner side surface;
a driving head extending through said axial holes in said first and second annular hold portions and obstructed by said inner side surface of said shoulder member from removal from said front handle section through said axial hole in said second annular hold portion, said driving head having an exposed section extending outwardly from said outer side surface through said axial hole in said second annular hold portion; and
a position limiting unit including at least one stop member disposed on said exposed section, at least one compression spring disposed between said inner side surface of said shoulder member and said driving head, and at least one abutment member disposed between said compression spring and said inner side surface of said shoulder member, said compression spring biasing said driving head away from said second annular hold portion along said axis to allow said stop member to contact said bush unit, so as to prevent said driving head from removal from said front handle section through said axial hole in said first annular hold portion.

2. The pneumatic tool as claimed in claim 1, wherein said driving head further has a shoulder surface formed with a blind hole, said compression spring being confined within said blind hole.

3. The pneumatic tool as claimed in claim 1, wherein said driving head has a maximum diameter that is smaller than a diameter of said axial hole in said first annular hold portion so that, during assembly, said driving head is inserted through said axial hole in said first annular hold portion and into said axial hole in said second annular hold portion.

4. The pneumatic tool as claimed in claim 1, wherein said shoulder member extends into said axial hole in said second annular hold portion.

5. The pneumatic tool as claimed in claim 4, wherein said second annular hold portion further has a flange extending into said axial hole in said second annular hold portion, and said shoulder member has a small-diameter section and a large-diameter section that are interconnected, said large-diameter section having an outer peripheral surface in contact with a wall of said second annular hold portion defining said axial hole, said small-diameter section having a diameter smaller than that of said large-diameter section so as to define an annular shoulder surface therebetween, said annular shoulder surface abutting against said flange.

6. The pneumatic tool as claimed in claim 4, wherein said bush unit further includes a washer abutting against said outer side surface of said shoulder member.

7. The pneumatic tool as claimed in claim 1, wherein said stop member is configured as a pin, and extends through said exposed section of said driving head along a direction perpendicular to said axis.

8. The pneumatic tool as claimed in claim 1, wherein said exposed section of said driving head has an outer surface formed with an annular groove, and said stop member is configured as a C-shaped retaining ring received within said annular groove.

9. The pneumatic tool as claimed in claim 1, wherein said shoulder member is formed integrally with said second annular hold portion.

10. The pneumatic tool as claimed in claim 9, wherein said bush unit further includes a washer disposed between and abutting against said inner side surface of said shoulder member and said abutment member, so as to prevent contact between said abutment member and said shoulder member.

11. The pneumatic tool as claimed in claim 9, further comprising a washer disposed between said outer side surface of said shoulder member and said stop member and abutting against said outer side surface of said shoulder member, so as to prevent contact between said stop member and said shoulder member.

12. The pneumatic tool as claimed in claim 9, wherein said abutment member is configured as a ball.
